(19) United States
(12) Patent Application Publication
(10) Pub. No.: US 2017/0271967 A1
(43) Pub. Date: Sep. 21, 2017

(54) ROTATOR STRUCTURE OF MOTOR

(71) Applicant: HYUNDAI MOTOR COMPANY, Seoul (KR)

(72) Inventors: Yongsung JANG, Hwaseong-si (KR); SangHwa DO, Seongnam-si (KR); WoongChan CHAE, Gwangmyeong-si (KR); Sangjin PARK, Hwaseong-si (KR)

(73) Assignee: HYUNDAI MOTOR COMPANY, Seoul (KR)

(21) Appl. No.: 15/250,465

(22) Filed: Aug. 29, 2016

(30) Foreign Application Priority Data
Mar. 21, 2016 (KR) 10-2016-0033447

(51) Int. Cl. H02K 19/02; H02K 3/18; H02K 1/24

(52) U.S. Cl. CPC H02K 19/02; H02K 1/24; H02K 3/18

(57) ABSTRACT

The present disclosure provides a rotor structure of a motor including: a plurality of rotor cores disposed in predetermined directions at a rotating member; a plurality of coils wound around each of the rotor cores; and a crossover portion which is formed at a predetermined region of the rotating member and through which one of the coils wound around one of the rotor cores is passed to another rotor core. The crossover portion may include an inner partition wall, intermediate partition walls and an outer partition wall which are formed at a predetermined distance from each other from the rotation center of the rotating member to the rotor cores, a first groove may be formed between the inner partition wall and the intermediate partition wall, a second groove may be formed between the intermediate partition wall and the outer partition wall, and the second groove may have a larger depth than the first groove.

### CROSS-REFERENCE TO RELATED APPLICATION

This application claims priority to and the benefit of Korean Patent Application No. 10-2016-0033447 filed Mar. 21, 2016, which is incorporated herein by reference in its entirety.

### FIELD

The present disclosure relates to a wound rotor motor, and more particularly, to a rotor structure of a motor, which structurally reduces interference between coils at a coil crossover portion formed between rotor cores.

### BACKGROUND

The statements in this section merely provide background information related to the present disclosure and may not constitute prior art.

In general, a hybrid vehicle or electric vehicle (referred to herein as an environmentally-friendly vehicle) may generate driving torque through an electric motor which acquires torque using electric energy. Hereinafter, the electric motor will be referred to as “drive motor”.

For example, the hybrid vehicle travels in an EV (Electric Vehicle) mode which is a pure electric vehicle mode using only power of the drive motor or an HEV (Hybrid Electric Vehicle) mode which uses torques of the engine and the drive motor as power. Moreover, a general electric vehicle travels using torque of the drive motor as power.

Representative examples of the drive motor used as a power source of an environmentally-friendly vehicle may include PMSM (Permanent Magnet Synchronous Motor) and WRSM (Wound Rotor Synchronous Motor).

In the WRSM, a coil is wound around a rotor core as well as a stator, such that the rotor can serve as an electromagnet and thus replace a permanent magnet of the PMSM.

The WRSM has a structure in which the rotor core having a coil wound therearound is disposed at a predetermined gap with the stator, and applies a current through a brush and a slip ring in order to generate magnetic fluxes.

In the WRSM, the winding fill factor of the rotor core as well as the stator must be increased and insulation between coils must be secured, in order to improve efficiency while reducing loss.

Furthermore, the WRSM has a coil crossover portion through which a coil wound around one rotor core is passed to another rotor core, and fixes the coil through a molding, coating or varnish in order to secure robustness of the coil crossover portion. However, we have found that a fundamental increase in robustness has a limitation. When the coil of the coil crossover portion is damaged during no-load acceleration or deceleration, an insulation breakdown may occur.

The above information disclosed in this Background section is only for enhancement of understanding of the background of the invention and therefore it may contain information that does not form the prior art that is already known in this country to a person of ordinary skill in the art.

Further areas of applicability will become apparent from the description provided herein. It should be understood that the description and specific examples are intended for purposes of illustration only and are not intended to limit the scope of the present disclosure.

### SUMMARY

The present disclosure provides a rotor structure of a motor, which is capable of structurally removing interference between coils at a coil crossover portion formed between rotor cores, thereby improving the operation stability of a motor and securing the rotation robustness of the rotor.

One embodiment of the present disclosure provides a rotor structure of a motor, including: a plurality of rotor cores disposed in predetermined directions at a rotating member; a plurality of coils wound around each of the rotor cores; and a crossover portion which is formed at a predetermined region of the rotating member and through which one of the coils wound around one of the rotor cores is passed to another rotor core. The crossover portion may include an inner partition wall, intermediate partition walls and an outer partition wall which are formed at a predetermined distance from each other from the rotation center of the rotating member to the rotor cores. A first groove may be formed between the inner partition wall and the intermediate partition wall, a second groove may be formed between the intermediate partition wall and the outer partition wall, and the second groove may have a larger depth than the first groove.

The outer partition wall may have coil paths which are formed at predetermined positions and through which one of the coils passing through the crossover portion is passed, and the intermediate partition walls may be arranged in the rotation direction of the rotating member so as to correspond to the respective rotor cores.

The rotor core may have a shoe formed at an end far from the rotating member in order to prevent separation of the coil wound around the rotor core.

The rotor core may have a coil groove formed on the outer circumference thereof in the coil winding direction, and corresponding to the coil.

The inner partition wall may be continuously formed in the rotation direction of the rotating member.

Another embodiment of the present disclosure provides a rotor structure of a motor, including: a plurality of rotor cores arranged in predetermined directions, respectively, from a rotating member toward the outside; a plurality of coils wound around each of the rotor cores; and a crossover portion which is formed in a predetermined region of the rotating member, and through which one of the coils wound around one of the rotor cores is passed to another rotor core. The crossover portion may include an inner partition wall and an outer partition wall which are formed at a predetermined distance from each other in a direction from the rotating member to the rotor core, and a first groove may be formed between the inner partition wall and the outer partition wall.

The outer partition wall may have coil paths which are formed at predetermined positions and through which one of the coils passing through the crossover portion is passed, and the intermediate partition wall may be formed at a position corresponding to the rotor core.

The rotor core may have a shoe formed at an end far from the rotating member, in order to prevent separation of the coil wound around the rotor core.

The rotor core may have a coil groove formed on the outer circumference thereof in the coil winding direction, and corresponding to the coil.

A distance from one surface of the rotor core to the bottom surface of the first groove may be set to a first height.

The coil path may have a depth corresponding to the bottom surface of the first groove.

According to the depicted embodiments of the present disclosure, when the coils wound around the rotor core are passed through the crossover portion, interference between the coils can be reduced to prevent durability reduction.

Furthermore, since fixing structures for fixing the coils passing through the crossover portions are removed or reduced, the material cost can be reduced, and the durability and quality can be increased.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a rotor structure of a motor according to an embodiment of the present disclosure.

FIG. 2 is a cross-sectional view of the rotor structure of the motor according to the embodiment of FIG. 1.

FIG. 3 is a plan view illustrating the rotor structure of the motor according to the embodiment of FIG. 1.

FIG. 4 is a perspective view illustrating a rotor core of a motor according to another embodiment of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereafter, embodiments of the present disclosure will be described in detail with reference to the accompanying drawings.

In addition, the size and thickness of each configuration shown in the drawings are arbitrarily shown for understanding and ease of description, but the present disclosure is not limited thereto and the thicknesses of the components are expanded to clarify a plurality of parts and regions.

In order to clearly describe the embodiments of the present disclosure, parts having no relation to description will be omitted. Throughout the entire specification, like reference numerals designate like elements.

In the following descriptions, terms such as first and second are used to distinguish elements from each other because the elements have the same name, and the order of the terms is not limited thereto.

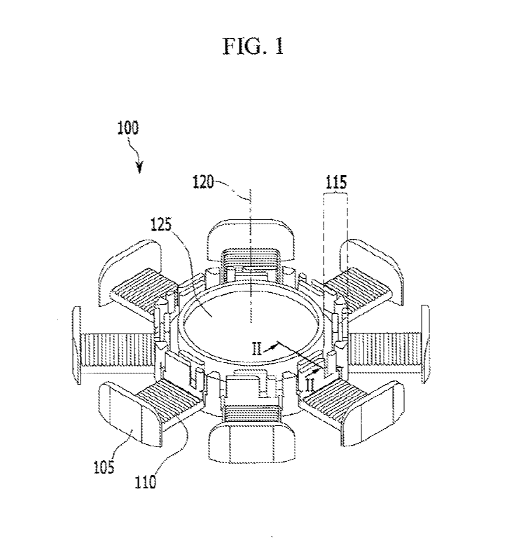

FIG. 1 is a perspective view of a rotor structure of a motor according to one embodiment of the present disclosure.

Referring to FIG. 1, the rotor structure 100 of the motor includes a rotating member 125, a crossover portion 115, a plurality of rotor cores 110, a rotation center axis 120 and a plurality of rotor shoes 105.

The rotating member 125 is disposed to rotate about the rotation center axis 120, and the rotor cores 110 are fixed to the outer circumference of the rotating member 125. The rotor cores 110 are arranged at predetermined angles around the rotation center axis 120.

The rotor core 110 has the rotor shoe 105 disposed at the front end thereof, the rotor shoe 105 having a wider structure than the rotor core 110.

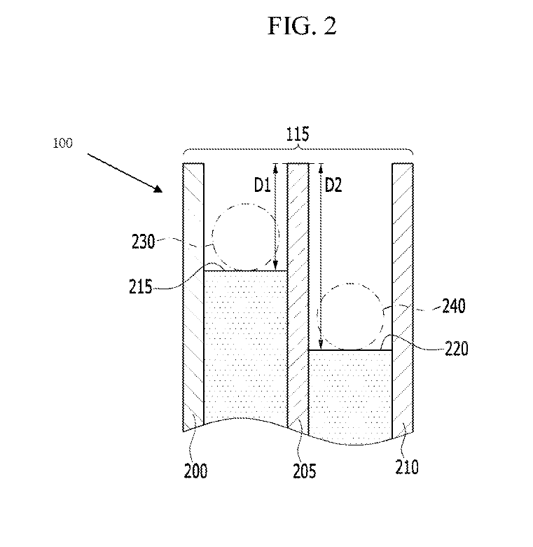

In the depicted embodiment of the present disclosure, the coil crossover portion 115 is formed between the rotating member 125 and the rear end of the rotor core 110 (i.e. the end of the rotor core 110 opposite the shoe 105). The crossover portion 115 is a part through which a coil wound around any one rotor core 110 is passed to another rotor core. Referring to FIG. 2, the structure of the crossover portion 115 will be described in more detail.

FIG. 2 is a cross-sectional view of the rotor structure of the motor according to one embodiment of the present disclosure.

Referring to FIG. 2, the crossover portion 115 includes an inner partition wall 200, an intermediate partition wall 205 and an outer partition wall 210, a first groove 215 is formed between the inner partition wall 200 and the intermediate partition wall 205, and a second groove 220 is formed between the intermediate partition wall 205 and the outer partition wall 210.

The first groove 215 has a first depth D1, the second groove 220 has a second depth D2, and the second depth D2 is larger than the first depth D1.

In the depicted embodiment of the present disclosure, a first coil 230 passing through the crossover portion 115 is passed through the first groove 215, and a second coil 240 is passed through the second groove 220. Since the first and second grooves 215 and 220 have different depths, interference is removed where the first coil 230 and the second coil 240 cross each other.

Thus, since the interference between the coils passing through the crossover portion 115 is removed or reduced, damage caused by the interference between the coils can be reduced, and durability reduction can be prevented.

Furthermore, since structures for fixing the coils passing through the crossover portion 115 are removed or reduced, the material cost can be reduced, and the entire durability and quality of the motor can be satisfied.

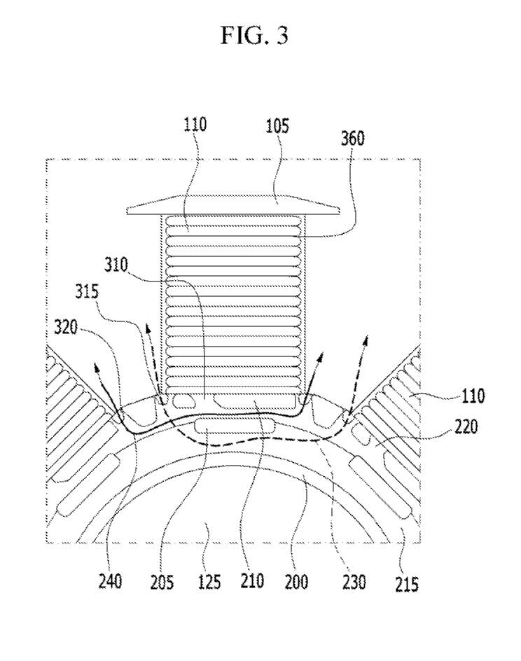

FIG. 3 is a plan view illustrating the rotor structure of the motor according to the present disclosure.

Referring to FIG. 3, the rotor stator of the motor includes the inner partition wall 200, the intermediate partition walls 205, the outer partition wall 210, the rotor cores 110 and the rotor shoes 105. The inner partition wall 200 is continuously formed in the rotation direction (i.e. radially or circumferentially), and the intermediate partition walls 205 are formed at a predetermined distance from each other in the rotation direction of the rotating member 125 so as to correspond to the respective rotor cores 110.

The outer partition wall 210 has coil paths which are formed at predetermined positions and through which the coil passes. More specifically, the coil paths include a first coil path 300, a second coil path 305, a third coil path 310, a fourth coil path 315 and a fifth coil path 320.

In the depicted embodiment of the present disclosure, the first coil 230 is passed through the crossover portion 115 via the first coil path 300, the first groove 215 and the fourth coil path 315, and the second coil 240 is passed through the crossover portion 115 via the second coil path 305, the second groove 220 and the fifth coil path 320.

Referring to FIG. 3, the first coil 230 passing through the third coil path 310 and the second coil 240 passing through the fifth coil path 320 via the second groove 220 do not interfere with each other where the first and second coils 230 and 240 cross each other, due to the difference in depth between the first and second grooves 215 and 220.

Moreover, the intermediate partition wall 205 can separate the first and second coils 230 and 240 from each other in the region of the crossover portion 115. Thus, the intermediate partition wall 205 can remove interference between the first and second coils 230 and 240, and reduce vulnerable portions, thereby improving the degree of freedom in design.

Therefore, when the first and second coils 230 and 240 are passed through the crossover portion 115, the interference therebetween can be removed or reduced and the damage of the coils can be reduced, which makes it possible to prevent reduction in durability of the entire rotor structure 100.

Moreover, since fixing structures for fixing the coils passing through the crossover portion 115 can be removed or reduced, the material cost can be reduced, and the entire durability and quality of the motor can be satisfied.

In FIG. 3, the rotor core 110 has a coil groove 360 formed at one side of the outer circumference thereof, the coil groove 360 corresponding to the shape of the coil wound around the rotor core 110. The coil seated in the coil groove 360 is effectively prevented from being separated from the rotor core 110 during the rotation operation.

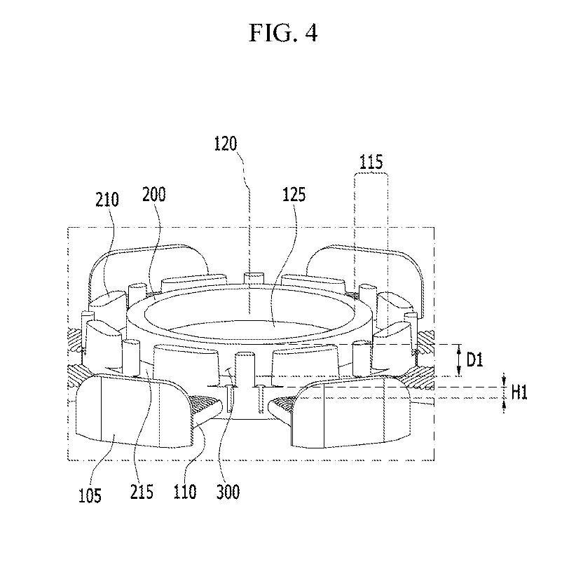

FIG. 4 is a perspective view illustrating a rotor core of a motor according to another exemplary embodiment of the present disclosure.

Referring to FIG. 4, the rotor structure of the motor includes a plurality of rotor shoes 105, a plurality of rotor cores 110, a crossover portion 115, a rotating member 125, a rotation center axis 120, a first groove 215, an inner partition wall 200 and an outer partition wall 210.

The rotating member 125 is disposed to rotate about the rotation center axis 120, the crossover portion 115 is disposed outside the rotating member 125, and the rotor cores 110 are fixed at a predetermined distance on the outer circumference of the crossover portion 115 in the rotation direction of the rotating member 125.

The rotor shoes 105 are disposed at the outer ends of the rotor cores 110, and coils are wound around the respective rotor cores 110. Furthermore, a coil wound around one of the rotor cores 110 is wound around another rotor core through the crossover portion 115.

The crossover portion 115 includes the inner partition wall 200, a first groove 215 and the outer partition wall 210, the first groove 215 has a first depth D1, and the outer partition wall 210 has a coil path 300 formed therein, the coil path 300 having a depth corresponding to the depth D1 of the first groove 215.

In this embodiment of the present disclosure, a distance from one surface of the rotor core 110 (e.g. the top surface in FIG. 4) to the bottom surface of the first groove 215 is set to a first height H1. Thus, In this case, the angle at which the coils are bent becomes gentle, and the durability can be improved.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 100: Rotor structure | 105: Rotor shoe |
| 110: Rotor core | 115: Crossover portion |
| 120: Rotation center axis | 125: Rotor core |
| 200: Inner partition wall | 205: Intermediate partition wall |
| 210: Outer partition wall | 215: First groove |
| 220: Second groove | 230: First coil |
| 240: Second coil | 300: First coil path |
| 305: Second coil path | 310: Third coil path |
| 315: Fourth coil path | 320: Fifth coil path |

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A rotor structure of a motor, comprising:
a rotating member defining a rotation center and having a plurality of rotor cores disposed in predetermined directions from the rotation center;
a plurality of coils wound around each of the rotor cores; and
a crossover portion which is formed at a predetermined region of the rotating member and through which one of the coils wound around one of the rotor cores is passed to another rotor core;
wherein the crossover portion comprises an inner partition wall, intermediate partition walls and an outer partition wall which are formed at a predetermined distance from each other from the rotation center of the rotating member to the rotor cores; and
wherein a first groove formed between the inner partition wall and the intermediate partition wall, a second groove formed between the intermediate partition wall and the outer partition wall, and wherein the second groove has a larger depth than the first groove.

2. The rotor structure of claim 1, wherein:
the outer partition wall has coil paths which are formed at predetermined positions and through which one of the coils passing through the crossover portion is passed, and
the intermediate partition walls are arranged in the rotation direction of the rotating member so as to correspond to the respective rotor cores.

3. The rotor structure of claim 2, wherein:
the rotor core has a shoe formed at a radial end thereof in order to prevent separation of the coil wound around the rotor core.

4. The rotor structure of claim 2, wherein:
the rotor core has a coil groove formed on the outer circumference thereof in the coil winding direction, and corresponding to the coil.

5. The rotor structure of claim 2, wherein:
the inner partition wall is continuously formed in the rotation direction of the rotating member.

6. The rotor structure of claim 1, wherein:
the one of the coils passed through the crossover portion crosses over another of the coils passed through the crossover portion at an intersection point located in the crossover portion adjacent the first and second grooves.

7. A rotor structure of a motor, comprising:
a rotating member defining a rotation center and having a plurality of rotor cores arranged in predetermined directions extending outward from the rotation center;
a plurality of coils wound around the rotor cores; and
a crossover portion formed in a predetermined region of the rotating member, and through which one of the coils wound around one of the rotor cores is passed to another rotor core;
wherein the crossover portion comprises an inner partition wall and an outer partition wall which are formed at a predetermined distance from each other in a direction from the rotating member to the rotor core; and
a first groove formed between the inner partition wall and the outer partition wall.

8. The rotor structure of claim 7, wherein:
the outer partition wall has coil paths which are formed at predetermined positions and through which one of the coils passing through the crossover portion is passed, and the inner partition wall is formed at a position corresponding to the rotor core.

9. The rotor structure of claim 8, wherein:
the rotor core has a shoe formed at a radial end thereof and configured to prevent separation of the coil wound around the rotor core.

10. The rotor structure of claim 8, wherein:
the rotor core has a coil groove formed on the outer circumference thereof in the coil winding direction, and corresponding to the one of the coils.

11. The rotor structure of claim 8, wherein:
a distance from one surface of the rotor core to a bottom surface of the first groove is set to a first height.

12. The rotor structure of claim 11, wherein:
the coil path formed in the outer partition wall has a depth corresponding to the bottom surface of the first groove.

13. The rotor structure of claim 11, wherein:
the one of the coils is wound around one of the rotor cores to define a start portion and an end portion of the one of the coils, the one of the coils having a wound height corresponding to the first height.
